(19) United States
(12) Patent Application Publication
(10) Pub. No.: US 2014/0110510 A1
(43) Pub. Date: Apr. 24, 2014

(54) Apparatus Including at Least an Impeller or Diverter and for Dispensing Carbon Dioxide Particles and Method of Use

(71) Applicant: Cold Jet LLC, Loveland, OH (US)

(72) Inventors: Michael E. Rivir, Norwood, OH (US); Scott Thomas Hardoerfer, Milford, OH (US)

(73) Assignee: Cold Jet LLC, Loveland, OH (US)

(21) Appl. No.: 14/062,118

(22) Filed: Oct. 24, 2013

Related U.S. Application Data
(60) Provisional application No. 61/717,818, filed on Oct. 24, 2012.

(51) Int. Cl. B02C 19/00; B65G 11/20; F25J 1/00

(52) U.S. Cl. CPC B02C 19/0056; F25J 1/0027; B65G 11/206
USPC 241/27; 241/101.4; 193/31 A

(57) ABSTRACT

Carbon dioxide or any suitable material is dispensed by a system into one or more containers. An impeller within a transport produces carbon dioxide particles at one or more desired sizes. Particles sized to be sufficiently small enough to still maintain particle integrity are produced and advance through the transport, while particles of insufficient integrity are directed toward a divert and a diverter prevents the insufficient particles from being misdirected into a separate transport passageway.

### RELATED APPLICATION

This application claims priority to U.S. provisional patent application Ser. No. 61/717,818, which was filed on Oct. 24, 2012, the entirety of which is incorporated herein by reference for all purposes.

### TECHNICAL FIELD

The present invention relates to creating and directing solid particles of a cryogenic material, and is particularly directed to a method and apparatus for breaking a strand of cryogenic material into carbon dioxide particles and diverting the carbon dioxide particles.

### BACKGROUND OF THE INVENTION

Carbon dioxide systems, such as for creating solid carbon dioxide particles, are well known, and along with various associated component parts, are shown in U.S. Pat. Nos. 4,843,770, 5,018,667, 5,050,805, 5,071,289, 5,188,151, 5,249,426, 5,288,028, 5,301,509, 5,473,903, 5,520,572, 6,024,304, 6,042,458, 6,346,035, 6,695,679, and 6,824,450, all of which are incorporated herein by reference. Additionally, U.S. Patent Provisional Application Ser. No. 61/394688 filed Oct. 19, 2010, for METHOD AND APPARATUS FOR FORMING CARBON DIOXIDE PARTICLES INTO BLOCKS, U.S. patent application Ser. No. 13/276,937, filed Oct. 19, 2011, for METHOD AND APPARATUS FOR FORMING CARBON DIOXIDE PARTICLES INTO BLOCKS, U.S. Patent Provisional Application Ser. No. 61/487837 filed May 19, 2011, for METHOD AND APPARATUS FOR FORMING CARBON DIOXIDE PARTICLES, U.S. Patent Provisional Application Ser. No. 61/589551 filed Jan. 23, 2012, for METHOD AND APPARATUS FOR SIZING CARBON DIOXIDE PARTICLES, and U.S. Patent Provisional Application Ser. No. 61/592313 filed Jan. 30, 2012, for METHOD AND APPARATUS FOR DISPENSING CARBON DIOXIDE PARTICLES, are hereby incorporated by reference. Although this patent refers specifically to carbon dioxide in explaining the invention, the invention is not limited to carbon dioxide but rather may be applied to any suitable cryogenic material. Thus, references to carbon dioxide herein are not to be limited to carbon dioxide but are to be read to include any suitable cryogenic material.

Solid cryogenic material, such as solid carbon dioxide, has many uses. Some uses are met, at least in part, by dispensing the solid cryogenic material into a container, or, in a production environment, into a plurality of containers. It is sometimes desirable to control the size of particles formed from the cryogenic material and the advancement of the particles along one of multiple routes.

### BRIEF DESCRIPTION OF THE DRAWINGS

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a right front-side perspective view of an exemplary system of the present disclosure;

FIG. 2 is a perspective view of a dual-chute assembly of the system of FIG. 1 showing an exemplary first transport chute and an exemplary divert;

FIG. 3 is perspective view of the dual-chute assembly of FIG. 2;

FIG. 4 is a perspective exploded assembled view of the exemplary dual-chute assembly of FIG. 2;

FIG. 5 is a perspective view of an exemplary impeller;

FIG. 6 is a perspective view of a shaft of the impeller of FIG. 5;

FIG. 7 is a perspective view of a paddle of the impeller of FIG. 5;

FIG. 8 is a perspective view of the first transport chute of the exemplary dual-chute assembly of FIG. 2;

FIG. 9 is perspective view of the first transport chute of the dual-chute assembly of FIG. 2 in which the first transport chute includes an impeller assembly having the impeller of FIG. 5;

FIG. 10 is perspective view of an exemplary diverter;

FIG. 11 is perspective cross-sectional, cut-away view of the diverter of FIG. 10 fastened to the dual-chute assembly of FIG. 2;

FIG. 12 is a cross-sectional view taken along line 12-12 of FIG. 11;

FIG. 13 is a cross-sectional, cut-away view of the first transport chute of FIG. 9;

FIG. 14 is a partial cross-sectional view of the dual-chute assembly of FIG. 2 where the diverter of FIG. 10 is in a first position and aligned with the first transport chute of FIG. 2;

FIG. 15 is a partial cross-sectional, elevation view of the dual-chute assembly of FIG. 2 similar to FIG. 14 except the exemplary diverter of FIG. 10 is in a second position and aligned with the exemplary divert of FIG. 2 rather than with the first transport chute as shown in FIG. 14;

FIG. 16 is a perspective view of the exemplary dual-chute assembly of FIG. 2 showing an cut-away view through a wall portion of the exemplary first transport chute of FIG. 2;

FIG. 17 is a bottom, perspective view of the dual-chute assembly of FIG. 2 showing the diverter of FIG. 10 abutting a first wall portion of the divert of FIG. 2; and

FIG. 18 is a bottom, perspective view of the dual-chute assembly of FIG. 2 showing the exemplary diverter of FIG. 10 abutting a second wall portion of the divert of FIG. 2 that is disposed closer to the first transport chute of FIG. 2 than the first wall portion of FIG. 17.

Reference will now be made in detail to the present preferred embodiment of the invention, an example of which is illustrated in the accompanying drawings.

### DETAILED DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations. Referring in more detail to the drawings, an embodiment constructed according to the teachings of the present invention is described.

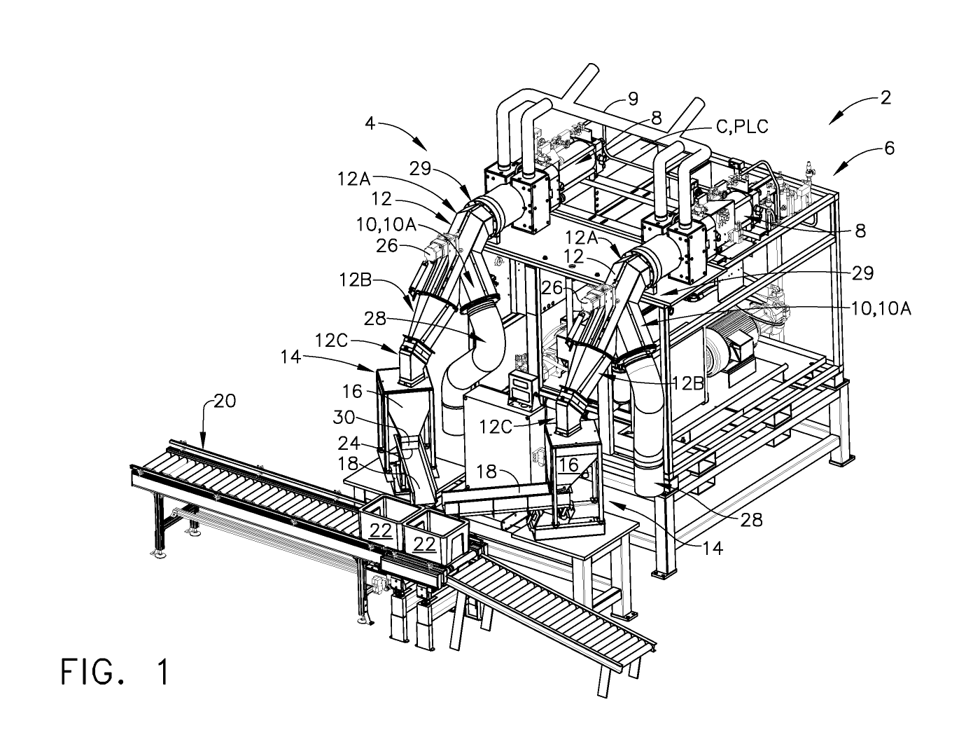

Referring to FIG. 1, there is shown carbon dioxide system, generally indicated at 2 (and such as described in U.S. Patent Provisional Application Ser. No. 61/592,313 filed Jan. 30, 2012, mentioned above). In the embodiment depicted, system 2 includes a pair of carbon dioxide dispensing lines 4, 6, each having substantially identical components which share certain common components. Only one of the two lines 4, 6 will be described in detail herein, it being understood that, except as otherwise noted, the other line is similarly configured and operable. Referring now to line 4, there is pelletizer 8 (such as described in U.S. Patent Provisional Application Ser. No. 61/487837 filed May 19, 2011, mentioned above).

Downstream of pelletizer 8 are divert 10, transport 12 and end use system 14. Divert 10 and transport 12 may be used with any suitable end use system, which could include containers simply configured to receive carbon dioxide particles for subsequent use such as for blasting at a remote location. In the embodiment depicted, end use system 14 includes hopper 16, tray 18, conveyer 20, and container 22.

Pelletizer 8 functions with respect to transport 12 as a source of carbon dioxide strands. Any suitable source of carbon dioxide particles may be used, such as, by way of non-limiting example only, a hopper being filled with particles from a source not integrally connected with system 2.

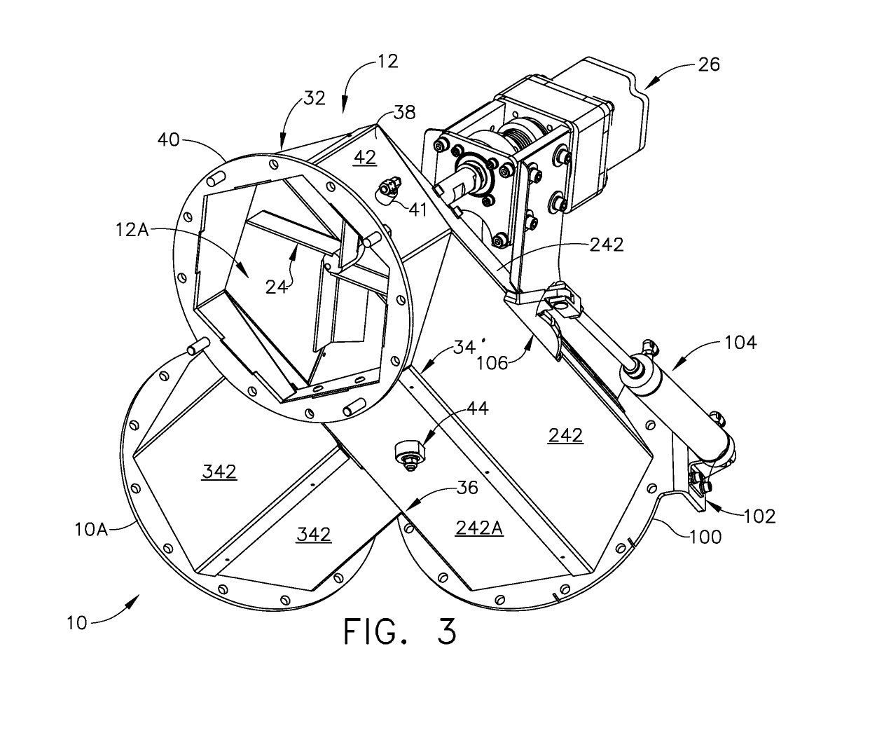

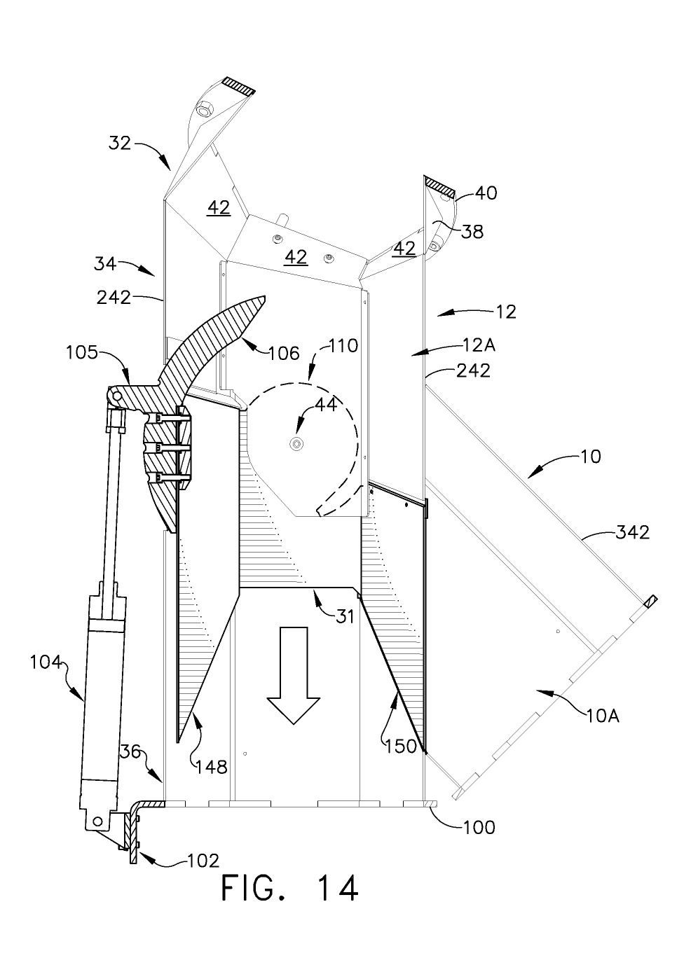

Pelletizer 8 produces the carbon dioxide strands that advance through system 2 to container 22 and includes a longitudinal axis, a first end, and a second end. Pelletizer 8 may include a die plate (not shown). The die plate may be 8 inches in diameter and have a plurality of apertures, also referred to as die openings, of about 3 millimeter diameter such that sufficiently small pellets of 3 millimeter diameter are produced. A cutter (not shown) or an impeller 24 (see FIG. 3) may be disposed within transport 12 a sufficient distance away from and in front of a die plate through which strands are extruded in pelletizer 8. The sufficient distance for the cutter, which shears and cuts a carbon dioxide strand extruded from the die plate into particles, is closer to the die plate than the sufficient distance S (see FIG. 13) for the impeller, which breaks a carbon dioxide strand via an applied force into particles.

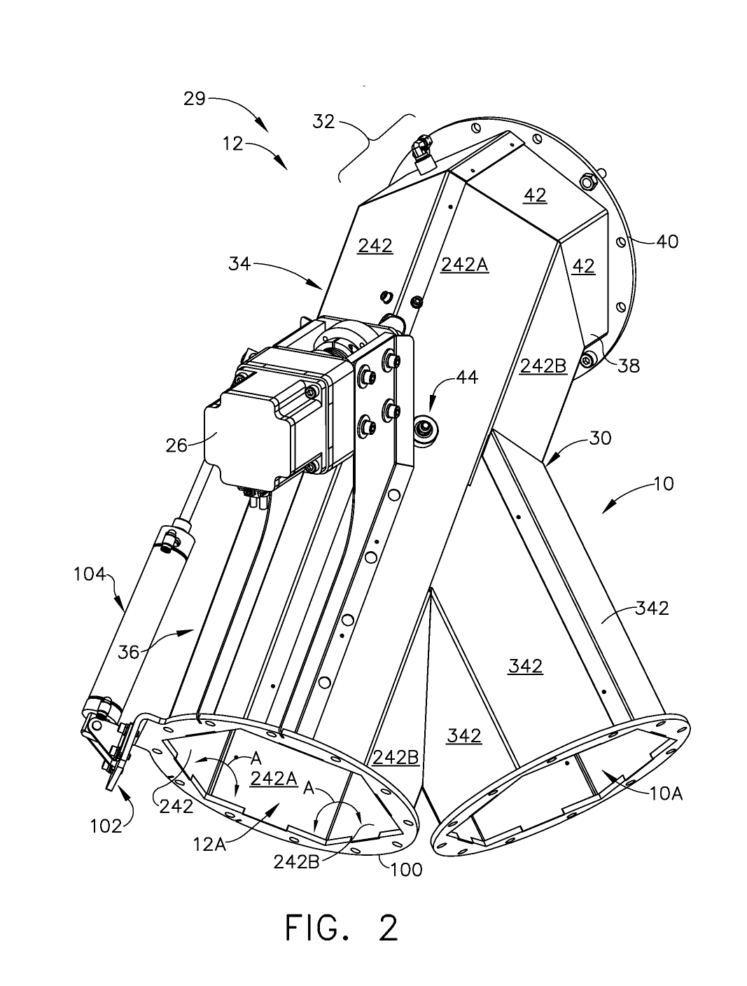

As also seen in FIG. 2, a motor of motor assembly 26 controls the rate of rotation of the impeller 24. The motor of motor assembly 26 may be set to any suitable rate such as, for example, 240 revolutions per minute. At start up, cut or broken strands may not be sufficiently solid to be considered pellets of sufficient quality and may rest on surfaces of adjoining walls 42 of horizontal chute section 38, described below (see FIGS. 2 and 13), which walls 42 are disposed below an open space between the impeller 24 and die plate. Blast jet 41 may be provided to provide air with a sufficient velocity to blast the insufficient quality pellets so disposed on the surface of walls 42 from walls 42 to divert 10.

The particles produced via pelletizer 8 and the impeller 24, which is described below, are sufficiently small to maintain particle integrity. For example, a particle maintains integrity as long as it remains a solid pellet and does not change into particle fines, such as grain-like substances. Particle fines need to be used immediately or risk immediate sublimation, while particle pellets of sufficiently density may last for several days, a period suitable for food storage purposes, for example, until the pellets completely sublimate. The pellets may additionally have a length of 4 millimeters, for example.

Any suitable material may be used for the components described herein, such as stainless steel or aluminum.

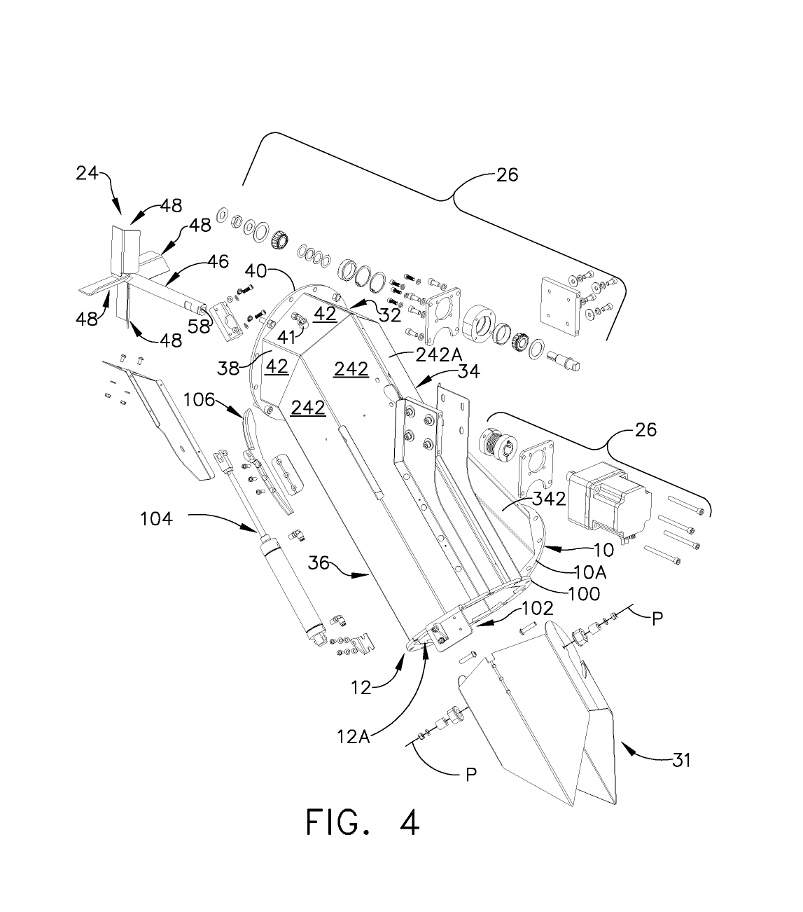

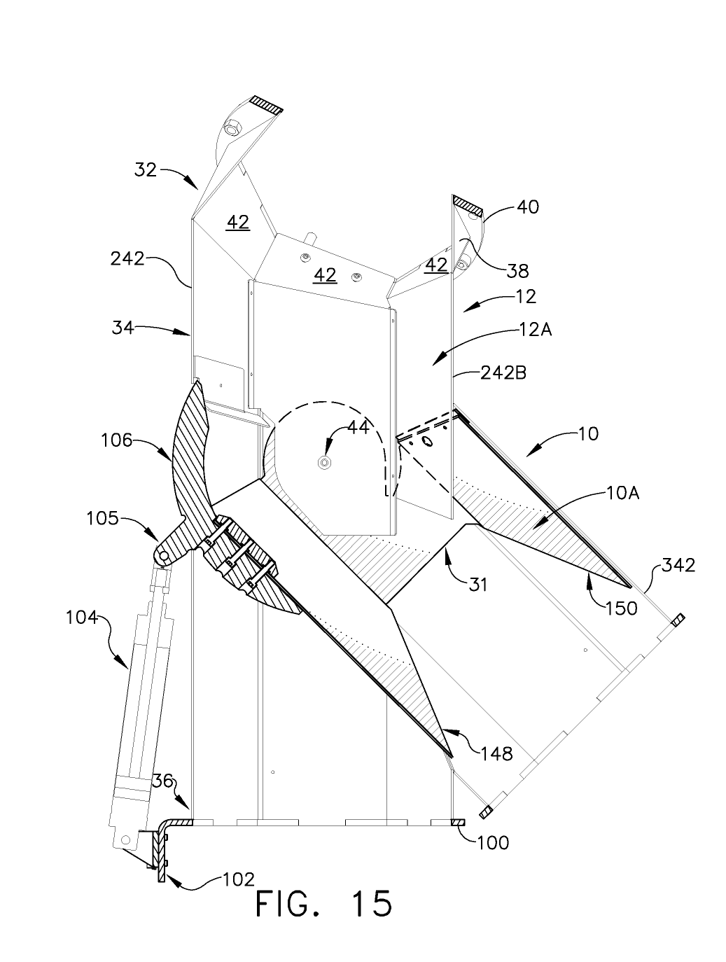

System 2 includes divert 10 and transport 12. Divert 10 communicates with discharge chute 28. Transport 12 includes transport source passageway 12A. Transport 12 communicates with first passageway 12B which communicates with second passageway 12C, which includes an opening (not shown) disposed over hopper 16. Divert 10 includes third passageway 10A, and diverter 31 (see FIG. 4) restricts communication between third passageway 10A of divert 10 and first passageway 12B of transport 12, as described further below. In a first position (see FIG. 14), diverter 31 permits communication between transport source passageway 12A and first passageway 12B of transport 12. Diverter 31 is moveable to a second position (see FIG. 15), in which it permits communication between transport source passageway 12A of transport 12 and third passageway 10A of divert 10.

Referring to FIG. 2, dual-chute assembly 29 is defined by transport source passageway 12A and divert 10 extending from side portion 30 of transport source passageway 12A. Transport source passageway 12A is defined by a first section 32, a second section 34, and a third section 36. First section 32 includes a chute section 38 extending from flange 40 that is configured to attach to the die plate end of pelletizer 8. Dual-chute assembly 29 may have any suitable cross sectional shape for the practice of the present invention. In the embodiment depicted, six walls 42 disposed in a hexagonal shape define chute section 38. Chute section 38 has a longitudinal axis that is substantially aligned with the longitudinal axis of pelletizer 8 when flange 40 is attached to pelletizer 8. Second section 34 includes six walls 242 extending from first section 32 at an angle such that a longitudinal axis of second section 34 is angled with respect to the longitudinal axis of first section 32. Third section 36 is an extension of second section 34 after the point at which divert 10 extends from side portion 30 of transport source passageway 12A, and third section 36 has a longitudinal axis aligned with the longitudinal axis of second section 34. Walls 242 of second section 34 extend through and are walls of third section 36. Divert 10 is defined by six walls 342 disposed in a hexagonal shape. The hexagonal cross-sectional shape of walls 42 defining horizontal chute section 38 and walls 242 defining both second section 34 and third section 36 of transport source passageway 12A is substantially geometrically similar to the hexagonal cross-sectional shape of walls 342 defining divert 10.

Pivot point 44 is disposed on a pair of opposing walls 242A along pivot axis P (see

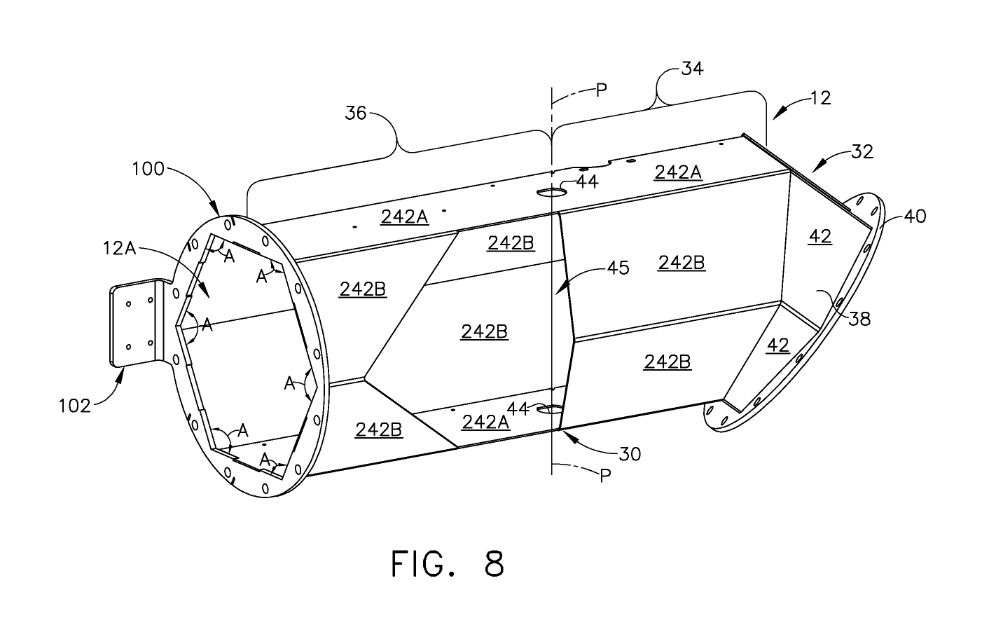

FIGS. 4 and 8). Referring to FIG. 8, each opposing wall 242A of the pair of opposing walls 242A extends at an angle A from one of a pair of adjoined walls 242B. The pair of opposing walls 242A are disposed on substantially parallel planes. Adjoined walls 242B are adjoined and positioned at angle A with respect to one another such that adjoined walls 242B lie on a pair of planes angled at angle A with respect to one another. Divert 10 (see FIG. 2) extends from adjoined walls 242B and side portion 30 of transport source passageway 12A and defines aperture 45 within adjoined walls 242B, as described further below.

Referring to FIG. 3, impeller 24 is disposed adjacent a distal end of horizontal chute section 38, along the longitudinal axis of pelletizer 8 when pelletizer 8 is attached to flange 40. The distal end of horizontal chute section 38 is disposed opposite a proximal end of horizontal chute section 38 that abuts flange 40. Impeller 24 is attached to and controlled by motor assembly 26, as described above.

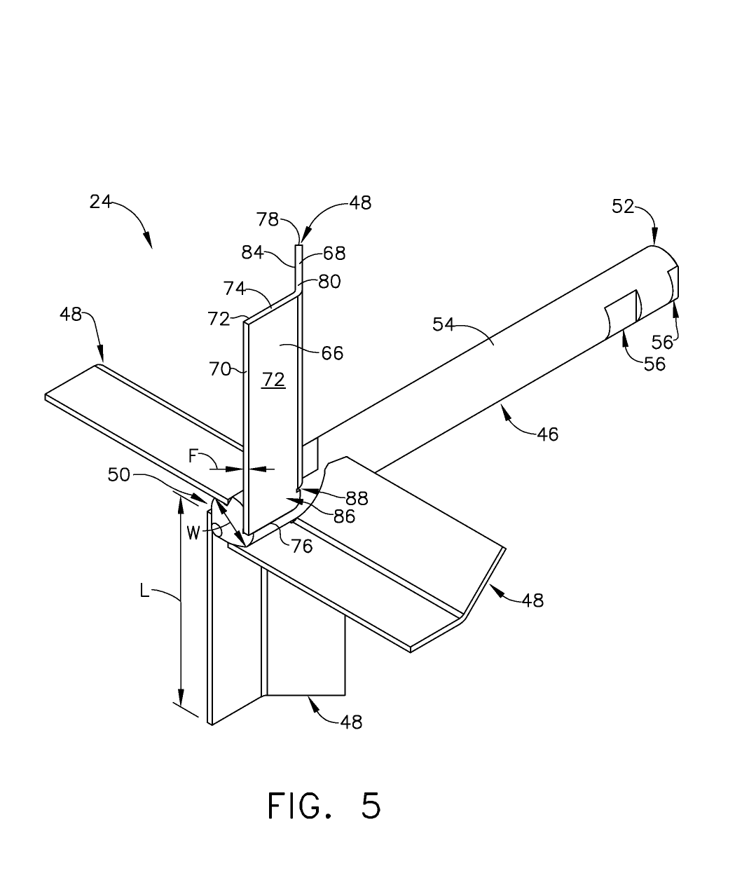

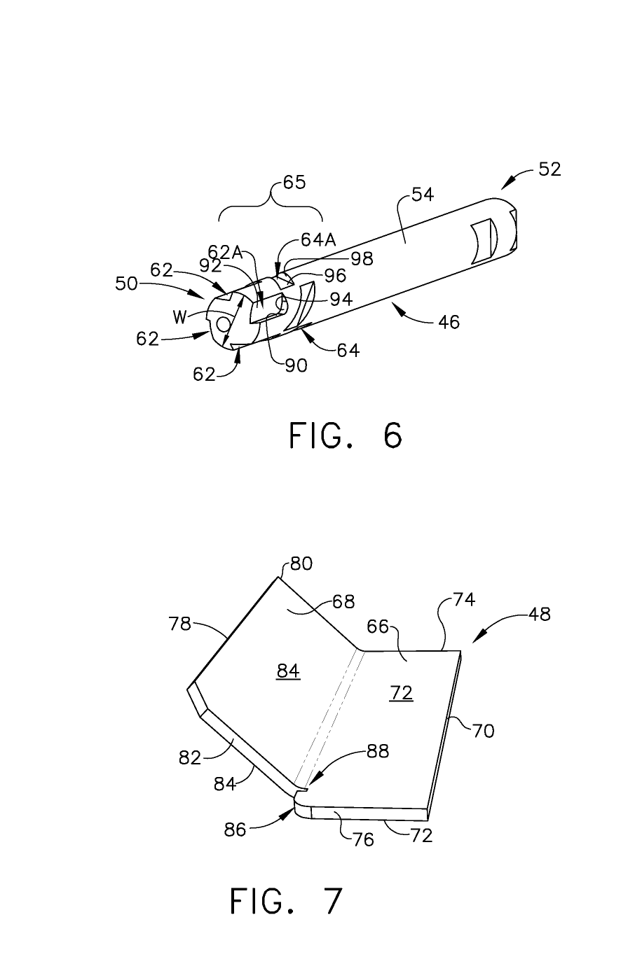

As shown in FIGS. 4 and 5, impeller includes components such as rotatable shaft 46 and paddles 48 (which may also be referred to as members). As shown in FIGS. 5 and 6, rotatable shaft 46 includes a die plate facing and proximal end 50, distal end 52, and sidewall 54 disposed between ends 50 and 52. Proximal end 50 has a diameter W. Cutouts 56 along distal end 52 may act as torsional cutouts and reduce stress. Distal end 52 of rotatable shaft 46 includes aperture 58 (see FIG. 4) configured to receive shaft 60 (see FIG. 13) of motor assembly 26 to attach impeller 24 to a proximal end of motor assembly 26 such that the motor of motor assembly 26 may control the rate of rotation of rotatable shaft 46.

As shown in FIG. 6, rotatable shaft 46 includes grooves 62 and 64 at and along proximal end 50 of rotatable shaft 46. Grooves 62 and 64 are sized and configured to receive faces of paddle 48, as described further below. Four groove sets are shown on rotatable shaft 46, and each groove shaft includes one groove 62 and one groove 64. For example, groove 62A and groove 64A define groove set 65.

Referring to FIGS. 5, 6 and 7, each paddle 48 includes second portion 66 and first portion 68 which, as shown in the depicted embodiment, may be generally planar and are angled with respect to one another. Second portion 66 includes frontal face 70 disposed between side surfaces 72. Frontal face 70 has a width F that is less than the maximum width W of proximal end 50 of rotatable shaft 46. Top face 74 and bottom face 76 distally extend from frontal face 70 and are substantially perpendicular to front face 70 while being disposed between side surfaces 72. First portion 68 includes rear face 78, top face 80, and bottom face 82. Top face 80 and bottom face 82 proximally extend from rear face 78, and faces 78, 80, and 82 are disposed between side surfaces 84. Disposed between bottom faces 76 and 82 are protrusion 86 and notch 88.

Paddles 48 are disposed in respective groove sets 65. First portion 66 is disposed in groove 62A and second portion 68 is disposed in groove 64A. Groove 62A is defined by first surface 90, second surface 92 disposed substantially perpendicular to first surface 90, and third surface 94 extending between distal ends of surfaces 90 and 92. Groove 64A is defined by fourth surface 96 disposed between a pair of wall surfaces 98. Bottom face 76 of first portion 66 is configured to be received on and abut against first surface 90, while an interior side surface 72 abuts against second surface 92 and protrusion 86 abuts against third surface 94. Bottom face 82 of second portion 68 is configured to be received on and abut against fourth surface 96, while each side surface 84 abuts against a respective wall surface 98. By receipt of paddles 48 into respective groove sets 65 as described above, paddles 48 form a box design around rotatable shaft 46, with each paddle positioned in a cantilever fashion with respect to rotatable shaft 46. This cantilevered box design allows for additional strength over an alternative design in which paddles 48 are attached to a smooth surface of sidewall 54 of rotatable shaft 46.

In operation, a carbon dioxide strand extrudes from a die plate (not shown) of pelletizer 8, as described above. The strand may be extruded, for example, at the speed of 14 inches per 6 seconds. Impeller 24 is spaced a sufficient distance S (see FIG. 13) from the die plate and flange 40 assembly such that the strand becomes brittle enough to be broken by the impact of rotation of paddles 48 of impeller 24. For example, the proximal end of impeller 24 may be spaced at least half a paddle length (defined as length L of paddle 48 and shown in FIG. 5) away from the die plate from which the strand exits. Spacing S allows the flexible strand to outgas more and become more brittle before the strand reaches impeller 24. With respect to the sufficient spacing for a cutter, the flexible strand does not become brittle enough to break due to impaction prior to reaching the cutter and is rather sheared by the cutter. Further, the reduced widths F of frontal faces 70 (defining a frontal area) differ from and are reduced with respect to front widths of known cutter designs, in which the widths of paddles frontal faces are greater than a maximum width of an attaching rotatable shaft. The reduced widths F allow a more unobstructed path over and less backpressure buildup than known cutter designs. Additionally, such a reduced frontal area allows system 2 to run without rotating impeller 24 so to produce full strands rather than particles or pellets at times (whereas excessive back pressure in known cutter designs would not allow such an operation to efficiently run as the strand would excessively clog against the larger frontal area of the known cutter design).

Carbon dioxide particles are formed from the broken pieces of the strand, and the carbon dioxide particles are directed along a side surface 84 of angled second portion 68 toward walls 242 of second section 34 of transport source assembly 12A to fall along the direction of the longitudinal angle of second section 34. The angled second portion 68 allows for more rigidity of paddle 48 than a flat parallel design would allow. By being directed along an angled path, rather than being directed in a more linear manner toward a wall 242, less force is impacted on the particle when it impacts and falls from the wall 242 (reducing a crushing action on the particles). This reduced impaction force allows for an improved and more uniform particle size distribution (mixing), less sublimation as the particles are less likely to be crushed, and a more evenly distributed particle flow. Also, less force is used to break particles via impeller 24 than a known cutter uses to shear similar particles, reducing the amount of power drawn from a motor to power and rotate rotatable shaft 46 of impeller 24 (than needed for a rotatable shaft of a known cutter) by more than half. And, as tapered bearings 200 of system 2 are spaced away from the cold region, for example, 4-6 inches, and positioned further from the die plate and in an ambient position, less wear occurs on the bearings than if the bearings were disposed in the cold region, as with known cutter designs.

The particles may fall toward first passageway 12B or third passageway 10A depending on whether a longitudinal axis of diverter 31 is aligned with the longitudinal axis of third section 36 of transport source passageway 12A or the longitudinal axis of divert 10, as described further below.

For example, carbon dioxide particles that may have undesirable characteristics, such as lacking sufficient integrity or size, and that are delivered from the first source, as described below, are directed through third passageway 10A of divert 10 for disposal, for example. FIG. 1 shows controller C that may communicate with programmable logic controller PLC to transmit instructions to block first passageway 12B from the first source (which blockage is shown in FIG. 15) until a first amount of time has passed. After the first time period had passed, which may be selected based on the determination that carbon dioxide particles produced during such period of time in the first source are of sufficient integrity, diverter 31 (see FIG. 4) may be moved into a position shown in FIG. 14, which movement is further described below, so as to direct particles from transport source passageway 12A into first passageway 12B and then to second passageway 12C. As shown in FIG. 1, the exit of second passageway 12C of transport 12 is disposed above hopper 16. Thus, the particles continue into hopper 16 from the exit of second passageway 12C. Additionally or alternatively, diverter 31 may be manually controlled.

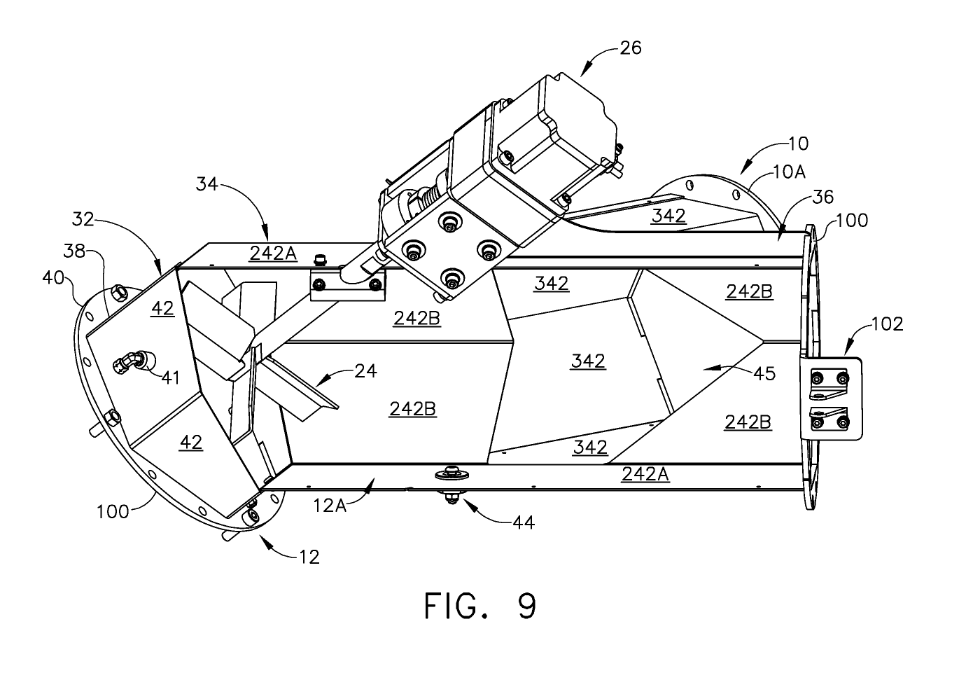

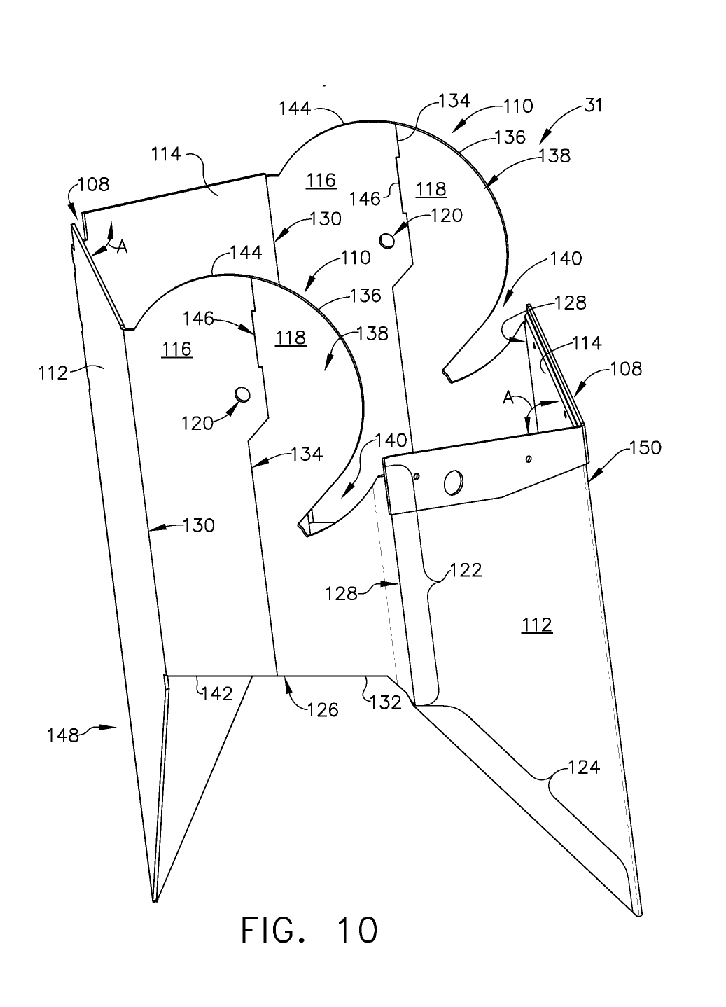

Referring to FIGS. 8 and 9, third section 36 has a distal end that abuts flange 100, which has distally extending rigid mount 102. Mount 102 is configured to attach to a distal end of actuator 104 (see FIG. 14), which may be, for example, a pneumatic cylinder. For example, mount 102 may attach to actuator 104 via fasteners such as screws. A proximal end of actuator 104 is configured to attach to an exterior portion 105 of arm 106. A portion of an interior surface of arm 106 abuts against and is fastened to an exterior surface of diverter 31, as described further below.

Referring to FIG. 10, diverter 31 includes a pair of opposing seal doors 108 and a pair of opposing door pivots 110. Each door pivot 110 includes a pair of substantially parallel and aligned walls 116 and 118. Walls 116 includes aperture 120 to align with axis P (see FIG. 8) and pivot points 44 when diverter 31 is attached to dual-chute assembly 29, as described below. Each seal door 108 (see FIG. 10) is defined by walls 112 and 114, and wall 112 is angled with respect to wall 114 by angle A. Doors 112 and 114 include a top rectangular portion 122 and a bottom triangular portion 124 that extends past bottom end 126 of adjoined walls 116 and 118. Rectangular portions 122 of doors 112 and 114 of one door 150 of seal doors 108 respectively extend from exterior side portions 128 of opposing walls 118 to meet at a vertex. Rectangular portions 122 of doors 112 and 114 of opposite door 148 of seal doors 108 respectively extend from exterior side portions 130 of opposing walls 116 to meet at a vertex.

Each wall 118 includes bottom portion 132, intermediate portion 134, and top curved portion 136. Top curved portion 136 includes circular protrusion 138 and notch 140. Each wall 116 includes bottom portion 142, top curved portion 144, and intermediate portion 146. Intermediate portion 146 is configured to matingly receive and abut against intermediate portion 134 of wall 118. Adjoining portions of top curved portion 144 of wall 116 and circular protrusion 138 of wall 118 have the same radius of curvature from apertures 120.

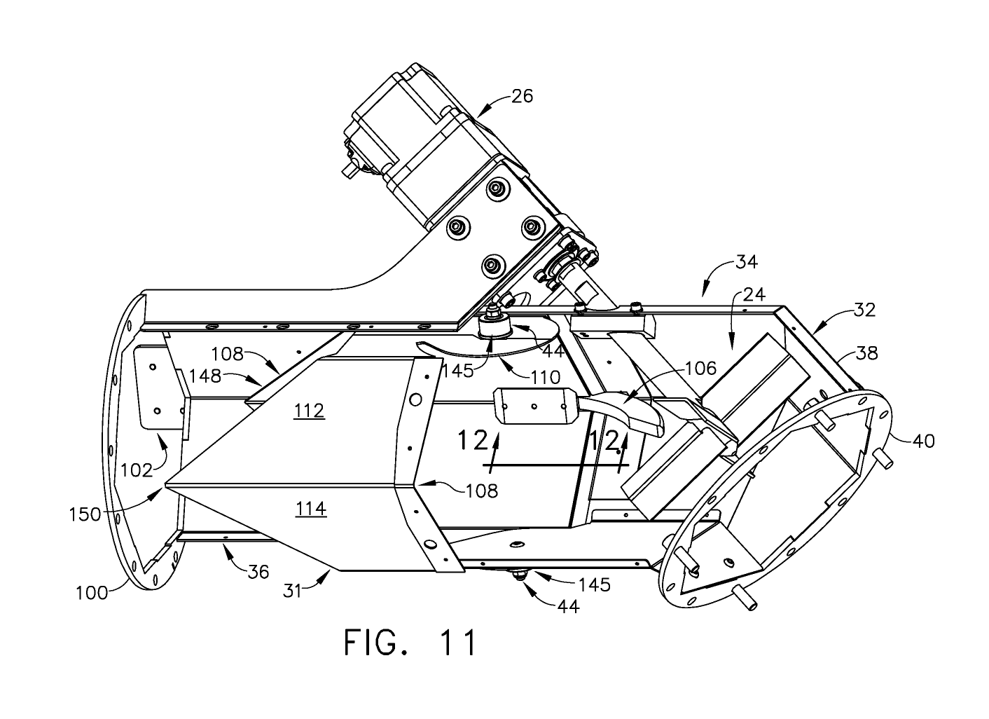

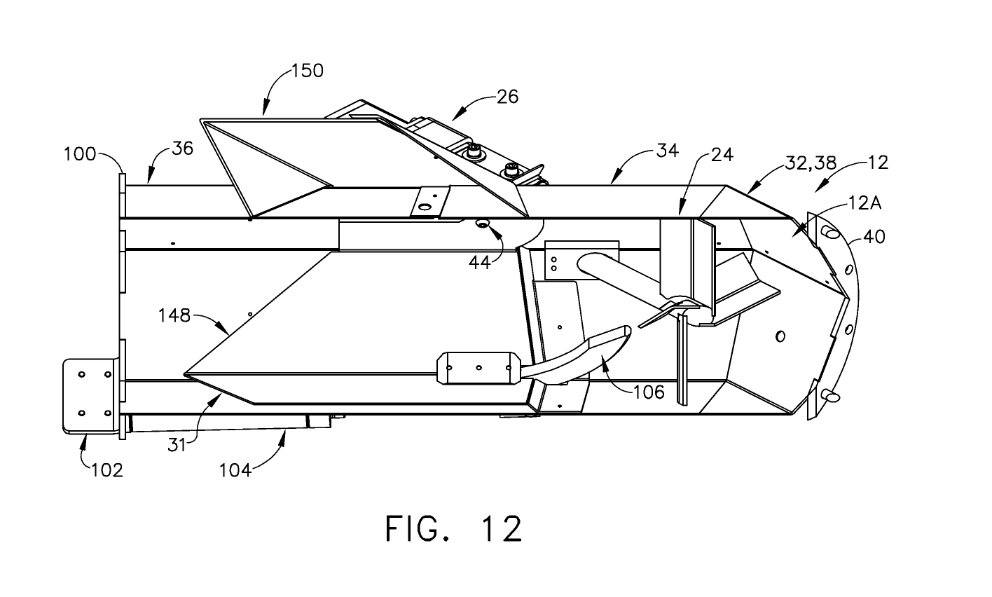

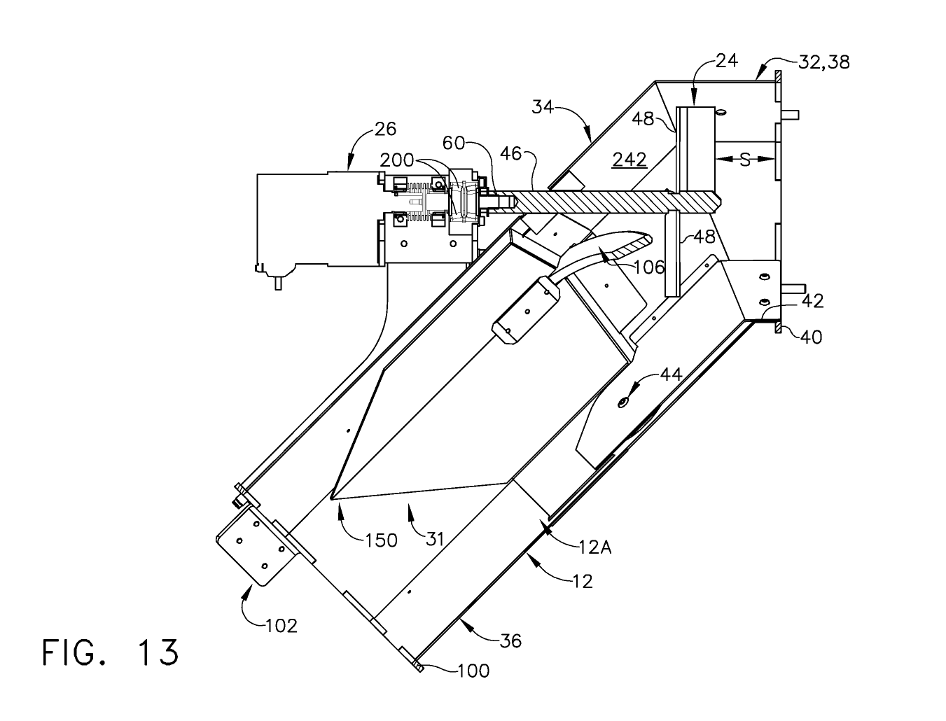

Referring to FIG. 11, diverter 31 is attached to walls 242A defining transport source passageway 12A. Each pivot point 44 of a wall 242A is aligned with a respective aperture 120 of walls 116 of diverter 31, and each wall 242A is attached to a door pivot 110 of diverter 31 via a fastening attachment, such as a nut and bolt assembly 145. When so attached, and when in a first position shown in FIG. 11 in which a longitudinal axis of diverter 31 is aligned with a longitudinal axis of third section 36 of transport source passageway 12A, first door 148 of seal doors 108 abuts against a pair of walls 242 forming and having a complementary shape, and second door 150 of seal doors 108 is aligned with and sealable against aperture 45 (see FIG. 9) defined by walls 242B. Such a first position is depicted through FIGS. 11-15.

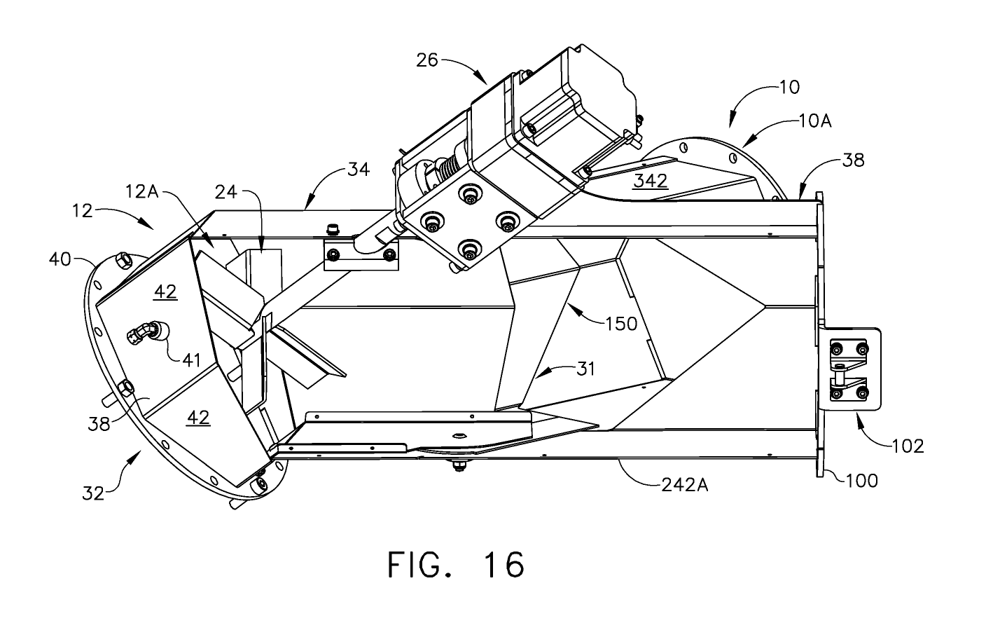

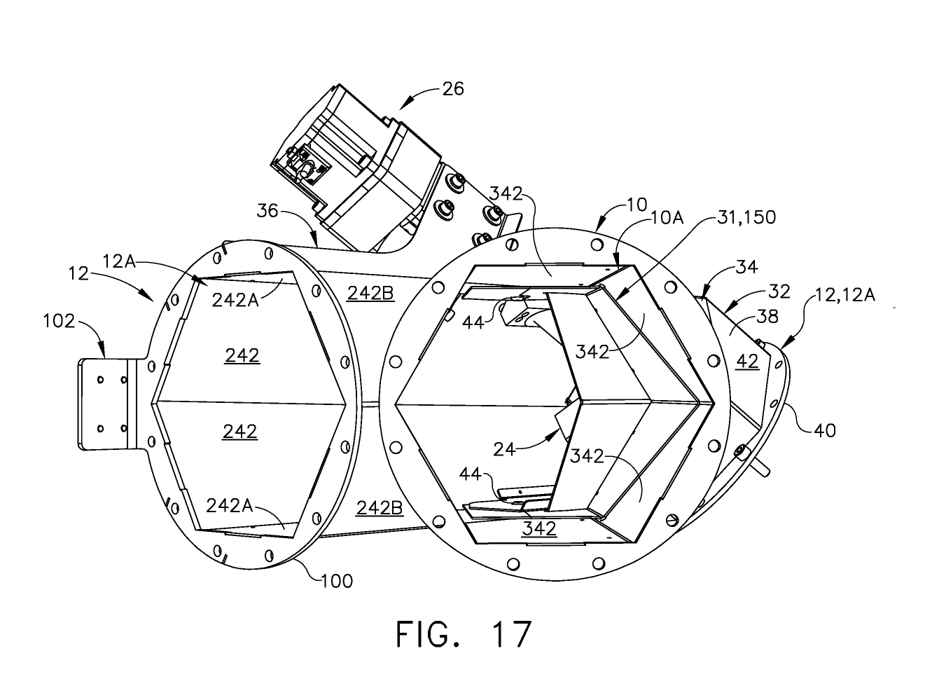

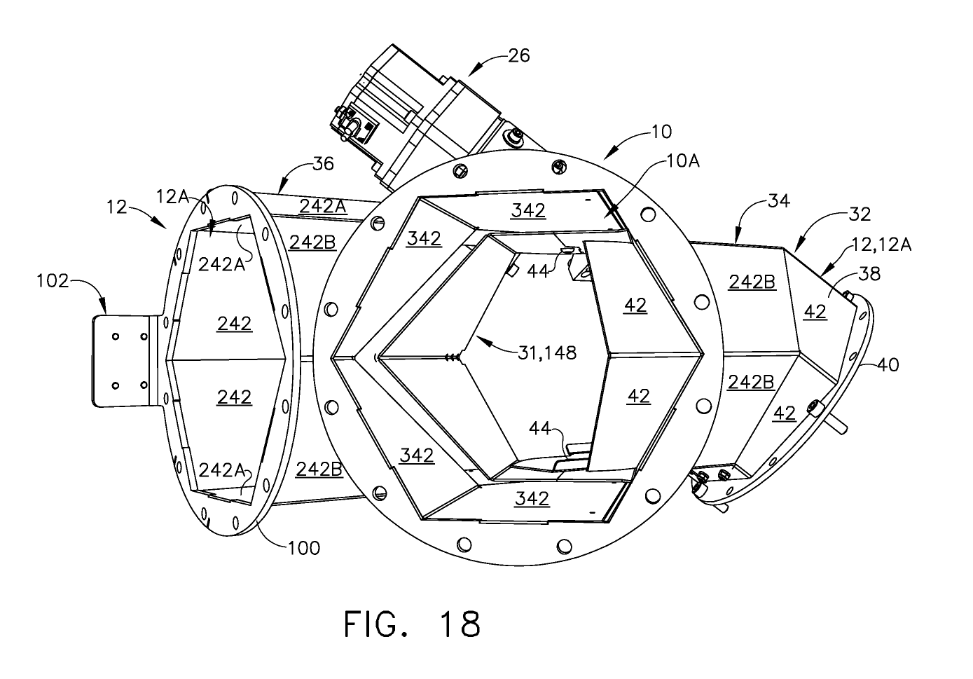

Diverter 31 is moveable from a first position (see FIG. 14) to a second position (see FIG. 15) via a counter-clockwise rotation of door pivots 110 about pivot points 44 such that second door 150 clears aperture 45 (see FIG. 9) of walls 242B and advances until second door 150 abuts a pair of adjoining walls 342 of divert 10 and first door 148 is aligned with and sealable against aperture 45. Such a second position is depicted through FIGS. 15-18. Arm 106 is attached to actuator 104 and diverter 31 as seen in FIGS. 14 and 15, such that actuation of actuator 104 produces the movement of diverter 31 from the first position to the second position.

In operation, diverter 31 has a shape and configuration that aligns with a longitudinal axis of first passageway 12B when diverter 31 is in the first position described above. In the first position (see FIG. 14), diverter 31 restricts communication of second section 34 of transport source passageway 12A with divert 10 and seals third section 36 of transport source passageway 12A off from divert 10. When pivoted to the second position (see FIG. 15) described above, diverter 31 restricts communication of second section 34 of transport source passageway 12A with third section 36 of transport source passageway 12A from divert 10 and seals third section 36 of transport source passageway 12A off from divert 10.

The foregoing description of an embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. Although only a limited number of embodiments of the invention is explained in detail, it is to be understood that the invention is not limited in its scope to the details of construction and arrangement of components set forth in the preceding description or illustrated in the drawings. The invention is capable of other embodiments and of being practiced or carried out in various ways. Also, in describing the preferred embodiment, specific terminology was used for the sake of clarity. It is to be understood that each specific term includes all technical equivalents which operate in a similar manner to accomplish a similar purpose. It is intended that the scope of the invention be defined by the claims submitted herewith.

1. An apparatus for producing particles from a cryogenic material, said apparatus comprising:
a. a die plate comprising a plurality of die openings and configured to extrude in a first direction a plurality of solid strands of said cryogenic material through said plurality die openings;
b. means for an impacting strands of said plurality of solid strands with force sufficient to break said strands into a plurality of particles, said means comprising:
i. a shaft rotating about an axis, said shaft having a first end;
ii. a plurality of members extending outwardly from said first end of said shaft, each respective member of said plurality of members comprising a respective frontal face spaced from said die plate, said respective frontal face having a respective width which is thin.

2. The apparatus of claim 1, wherein said plurality of members extend radially outwardly from said shaft.

3. The apparatus of claim 1, wherein said first end of said shaft has a maximum width which is greater than said respective width of each said respective frontal face.

4. The apparatus of claim 1, wherein at least one of said plurality of members comprise a first portion, said first portion being generally planar.

5. The apparatus of claim 4, wherein said first portion is disposed generally perpendicular to said die plate.

6. The apparatus of claim 4, wherein said at least one of said plurality of members comprises a second portion, said second portion being disposed non-planar to said first portion.

7. The apparatus of claim 1, wherein said respective frontal faces are spaced from said die plate a distance sufficient to allow said strands to become brittle enough to be broken into said pieces by impact with said respective members.

8. The apparatus of claim 1, wherein said plurality of members do not comprise a shearing edge.

9. The apparatus of claim 1, wherein each member of said plurality of members has a respective length, and wherein said first end of said shaft is spaced at least half of said respective length away from said die plate.

10. A method of creating a plurality of particles from a plurality of strands of a cryogenic material, said method comprising the steps of:
a. providing said plurality of strands;
b. rotating a shaft about an axis, said shaft comprising a plurality of members extending outwardly from a first end of said shaft, each respective member of said plurality of members comprising a respective frontal face, each said respective frontal face having a respective width which is thin;
c. impacting said plurality of strands with said plurality of members at locations whereat said plurality of strands have sufficiently outgassed so as to be brittle enough to be broken into said pieces by impact with said plurality of members.

11. The method of claim 10, further comprising the step of directing said plurality of particles along respective angled portion of said plurality of members.

12. A diverter disposed in a dual-chute system comprising a transport chute and a divert chute, the diverter comprising:
a. a pair of opposing door pivots, each door pivot comprising a pivot point, each pivot point aligned along a pivot axis, wherein each door pivot comprising a first portion and a second portion, wherein the first portion and the second portion lie on a first plane; and
b. a pair of opposing sealing doors disposed between the pair of opposing door pivots, wherein each door comprises a third portion and a fourth portion, wherein the third portion lies on a second plane, wherein the fourth portion lies on a third plane, and wherein the second plane is angled with respect to the third plane;
wherein the diverter is operable to pivot between a first position to a second position, and
wherein the diverter seals off a portion of the transport chute from the divert chute.

13. The diverter of claim 12, wherein when in the first position the diverter is disposed along a longitudinal axis of the transport chute, wherein when in the second position the diverter is disposed along a longitudinal axis of the divert chute.

14. The diverter of claim 12, wherein the diverter comprises a hexagonal cross-section.

15. The diverter of claim 14, wherein each of the transport chute and the divert chute comprises a hexagonal cross-section, wherein a door aperture is defined within a pair of angled walls disposed between the transport chute and the divert chute, and wherein the diverter is configured to pivot through the door aperture.

16. The diverter of claim 15, wherein when in the first position, one of the pair of opposing sealing doors of the diverter seals against the door aperture; and wherein when in the second position, the other of the pair of opposing sealing doors seals against the door aperture.
